(19) United States
(12) Patent Application Publication
(10) Pub. No.: US 2013/0076107 A1
(43) Pub. Date: Mar. 28, 2013

(54) WHEEL COVER AND MOUNTING DEVICE

(71) Applicants: Alan Manning Starnes, Greensboro, NC (US); Robert William Finley, Colfax, NC (US)

(72) Inventors: Alan Manning Starnes, Greensboro, NC (US); Robert William Finley, Colfax, NC (US)

(73) Assignee: VOLVO GROUP NORTH AMERICA, LLC, Greensboro, NC (US)

(21) Appl. No.: 13/703,105

(22) PCT Filed: Jun. 30, 2010
(86) PCT No.: PCT/US10/40542

§ 371 Date: Dec. 10, 2012

(51) Int. Cl. B60B 7/12

(52) U.S. Cl. CPC B60B 7/12
USPC 301/37.102

(57) ABSTRACT

A wheel cover includes a quick fasten and release device for securing the wheel cover to a vehicle wheel. The device includes a clamp mechanism extending from a central location on the wheel cover. The clamp includes grappling fingers that engage the wheel hub flange when drawn into engagement by a mechanism operated by a handle accessible from the outward facing surface of the wheel cover.

### FIELD OF THE INVENTION

The invention relates to wheel covers for wheels having exposed axle hubs, and more specifically, to a wheel cover and mounting device for a wheel having an exposed axle hub.

### BACKGROUND AND SUMMARY OF THE INVENTION

Wheel covers can provide aesthetic and aerodynamic benefits to a vehicle. To allow access the wheel for service, for example to access the valve stem or the lugs, it is preferable that a wheel cover be easily mounted and removed. Conventional wheel cover mountings include spring clips that engage the wheel rim, but these can be insecure, in that a jolt to the wheel can dislodge the wheel cover. Other devices include brackets and threaded fasteners that engage the wheel lugs, but these are inconvenient to mount and remove.

The invention provides a: wheel cover and mounting device that is simple and quick to attach and remove from a wheel hub.

The invention is advantageously applied to an aerodynamic wheel cover having an outward-facing surface designed for low air drag as the wheel turns and moves through space.

A wheel cover and mounting device according to the invention includes a wheel cover and a grappling device attached to the wheel cover. The grappling device includes gripping members for gripping the axle hub and a drive mechanism for selectively moving the gripping members between a gripping position and a releasing position,

According to one aspect of the invention, the grappling device includes a body having a flange on which the wheel or is mounted.

According to the invention, the gripping members are formed as tines or tongs having a hooked end to engage the axle hub. The tongs are pivotally mounted at an end opposite the hooked end to a. collar movably mounted on the body. The device further includes links that are pivotally mounted to a cuff. A link is pivotally connected to each of the tongs at a point spaced from the pivot end. The cuff is fixed to the body and the links control the movement of the tongs as the collar moves on the shaft to cause the tongs to close together to a gripping position or spread apart to a release position.

According to the invention, a drive mechanism is included for causing the collar to move on the shaft for selectively moving the gripping members between the gripping position and the release position. The drive mechanism includes a handle accessible from an outer surface of the wheel cover, the handle being attached to a shaft mounted to and extending perpendicularly from the wheel cover. The handle extends through a hole in the wheel cover.

According to one embodiment, the shaft is threaded and the collar carrying the gripping members is carried on a threaded carrier, the shaft and carrier being interengaged so that rotation of the shaft causes axial movement of the carrier and collar, which in turn causes the gripping members to move.

According to another embodiment, the handle includes a cam and is pivotally connected to the shaft. Pivoting the handle against the wheel cover causes the shaft to slide axially. The collar and carrier are fixed to the shaft and move with it. The axial movement of the collar causes the gripping members to move between the gripping position and the release position.

According to yet another embodiment, the shaft is mourned in body and spring biased toward the wheel cover. The collar is connected to the shaft so that axial sliding of the shaft causes the movement of the collar and corresponding pivoting of the gripping members. The shaft is pressed for movement by the handle connected to an end of the shaft accessible through a hole in the wheel cover.

### BRIEF DESCRIPTION OF THE DRAWINGS

The invention will be better understood by reference to the following detailed description read in conjunction with the appended drawing, in which;

FIG. 1 is a perspective view of a. wheel cover and mounting mechanism in accord with the invention shown with a section of an axle hub;

FIG. 2 is a perspective view of the wheel cover and mounting mechanism of FIG. 1 from an opposite side;

FIG. 3 is an exploded view of the wheel cover and mounting mechanism of FIG. 1;

FIG. 4 is a sectional view of the wheel cover and mounting mechanism taken along an axial plane of through the mounting mechanism;

FIG. 5 is a sectional view of the wheel cover showing an alternative operating device for the gripping: members; and,

FIG. 6 is a sectional view of the wheel cover showing another alternative operating device for the gripping members.

### DETAILED DESCRIPTION OF THE INVENTION

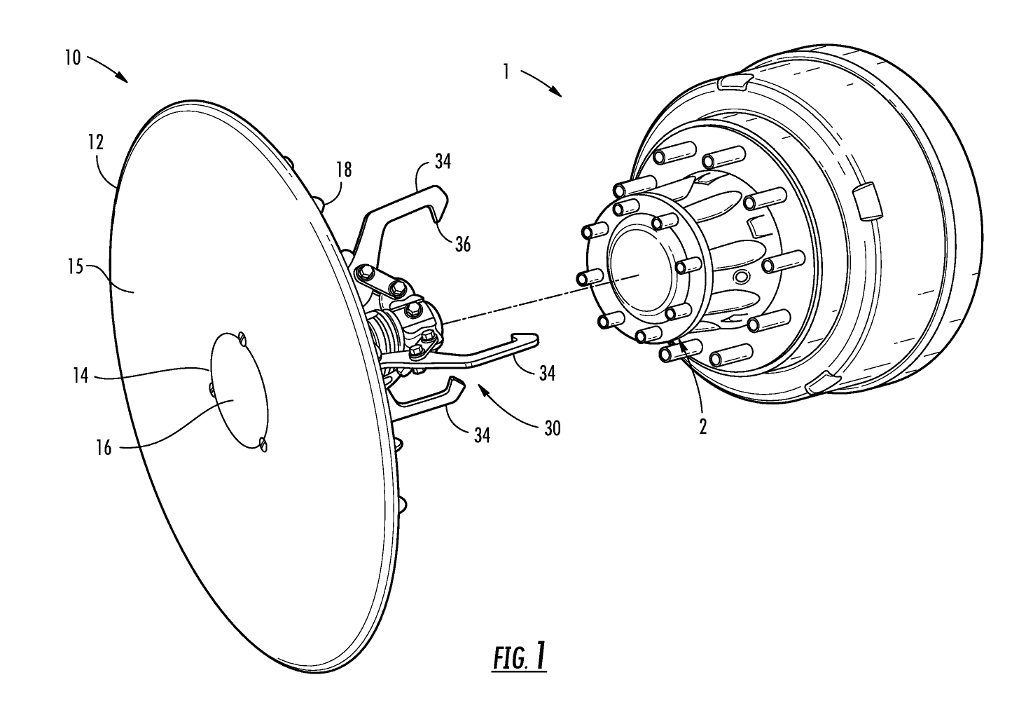

A wheel cover and mounting mechanism 10 according to an embodiment of the invention are shown in perspective view in FIG. 1 along with an end portion of an axle hub 1. The axle hub is of the type used on heavy trucks, and includes a flange 2.

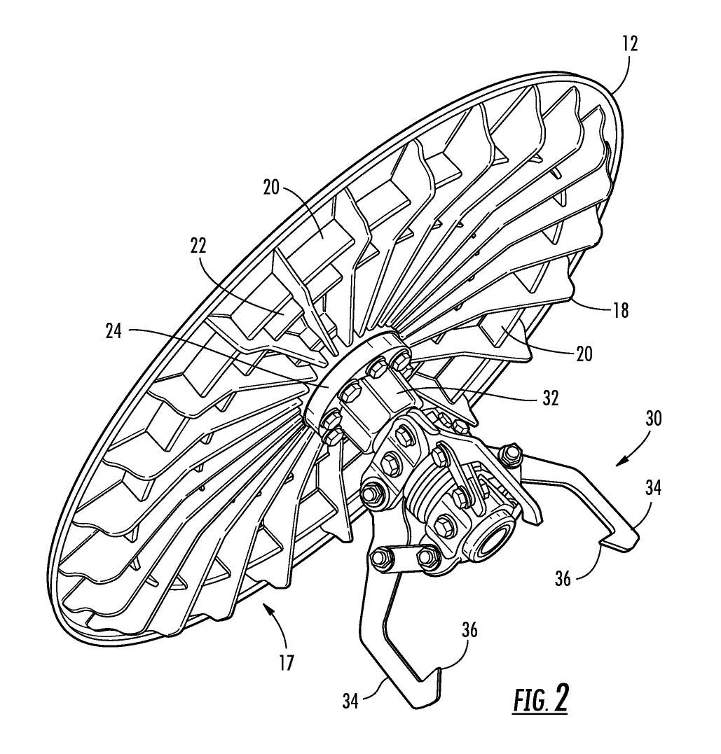

The wheel cover 12 is formed as a disc having a centrally located hole 14 covered by a cap 16. As described below, the hole 14 allows access to a handle for operating the mounting mechanism. An outer surface 15 of the wheel cover 12, that is, the side that faces outward from the wheel when the cover is in the an installed position, is preferably smooth to provide a low aerodynamic drag surface. Radially extending ribs 18 are formed on an inner surface 17, opposite the outer surface 15, to provide stiffness to the wheel cover and are shaped to seat on a wheel rim when the cover is installed on a wheel. As seen in FIG. 2, two circumferential ribs 20, 22 are formed on the inner surface, also to provide stiffness.

An embodiment of a mechanism 30 for gripping the axle hub 2 is shown in perspective view in FIG. 2. The mechanism 30 includes a body 32 mounted on the inner surface 17 of the wheel cover 12 at the hole 14. A boss 24 is provided on the wheel cover 12 to support the body 32. The mechanism 30 includes gripping members 34 integrated with a linkage, described below, that allows the gripping members 34 to be selectively moved between a gripping position and a release position. The gripping members 34 are shown here as tongs each having a hooked end 36 for gripping the flange 2 on the axle hub 1. As seen in the figure, there are three tongs equally circumferentially spaced on the body 32.

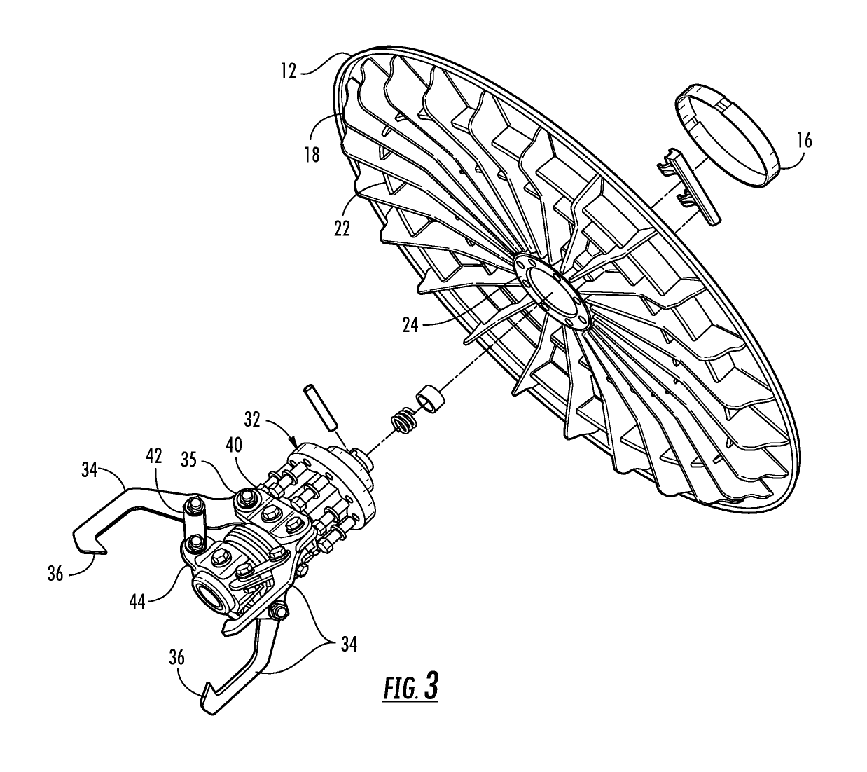

Turning to the exploded view of the mechanism in FIG. 3, the tongs are each pivotally connected at a head 35 (opposite the hooked end 36) to a collar 40. The collar 40 is slidably mounted on the body 32 for reciprocal movement in the axial direction, which when the device is mounted on the wheel cover 12 is perpendicular to the wheel cover. Each tong 34 is also connected at a point spaced from the head 35 by a link 42 to a cuff 44. The cuff 44 is fixedly mounted to the body 32, so that the links 42 control the movement of the tongs 34 as the collar slides in the axial direction. Movement of the collar 40 toward the wheel cover 12 causes the tongs 34 to move to the gripping position. Movement of the collar 40 away from the wheel cover 12 causes the tongs 34 to move to a spread, release position.

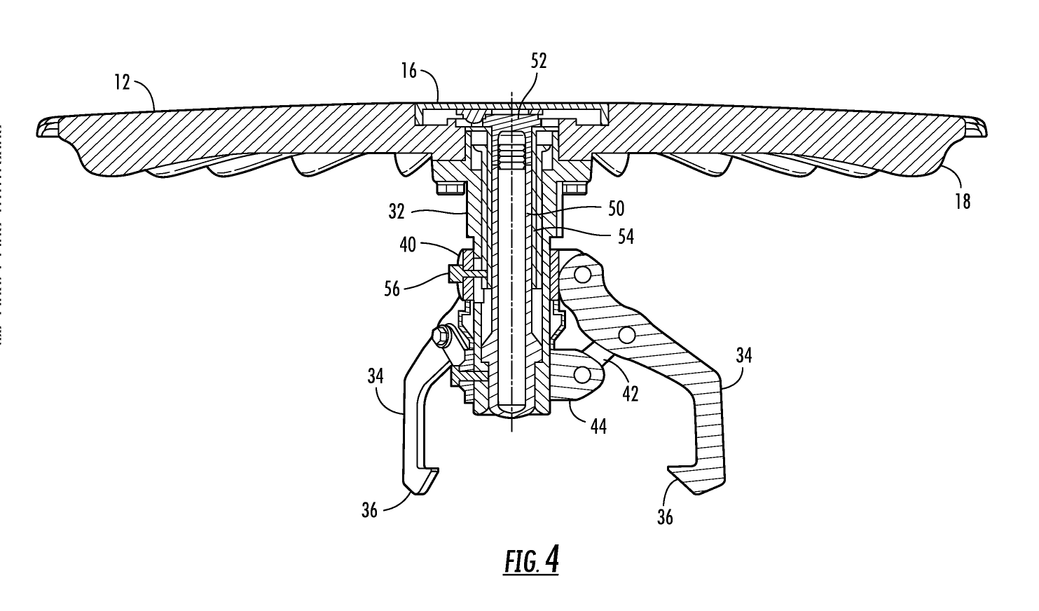

Turning to FIG. 4, which shows an axial section through the wheel cover 12 and gripping mechanism, an embodiment of a device for operating the gripping members 34 is illustrated. The body 32 is formed as a hollow cylinder, with the collar 40 and cuff 44 disposed on an outer surface thereof. A shaft 50 extends through the body 32 and into the hole 14 in the wheel cover 12. A handle 52 is attached to the shaft 50 and is accessible in the hole 14 under the cap 16. The handle 52 provides a means for a user to operate the mechanism.

A carrier 54 formed as a hollow cylinder is disposed in the body 32 in an annular space between the body and the shaft 50. The shaft 52 is threaded on an outer surface and the carrier 54 is threaded on an inner surface, the two threaded surfaces being interengaged so that rotation of the shaft 50 by the handle 52 causes, in the manner of a worm, axial movement of the carrier 54. The collar 40 is connected to the carrier 54 by a screw 56 that engages the carrier through a slot in the body 32. Thus, the collar 40 moves with the carrier 54 as the shaft 50 is rotated. Preferably, the shaft 50 and carrier 54 threads are pitched so that only two or three turns are required to close the gripping members on the flange.

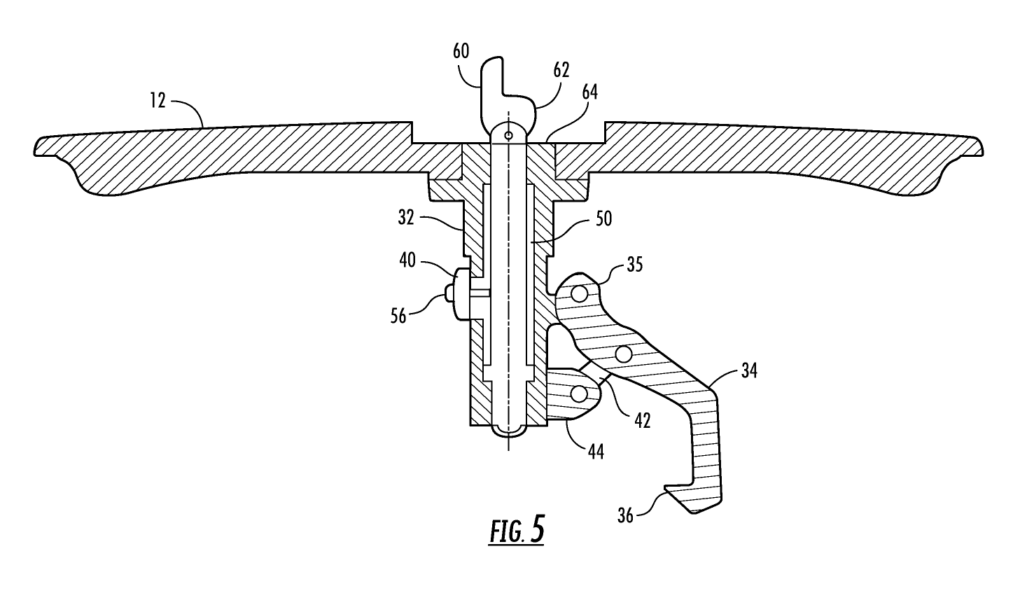

Other arrangements for operating the gripping members are possible. For example, as shown in the simplified view of FIG. 5, the collar 40 could be connected directly to the shaft 50, eliminating the carrier, and the shaft arranged for sliding movement in the body 32. A handle 60 could include a cam 62 and the wheel cover have a cam surface 64, by which pivoting or turning the handle moves the shaft axially in the body, and accordingly, moves the collar to operate the gripping members.

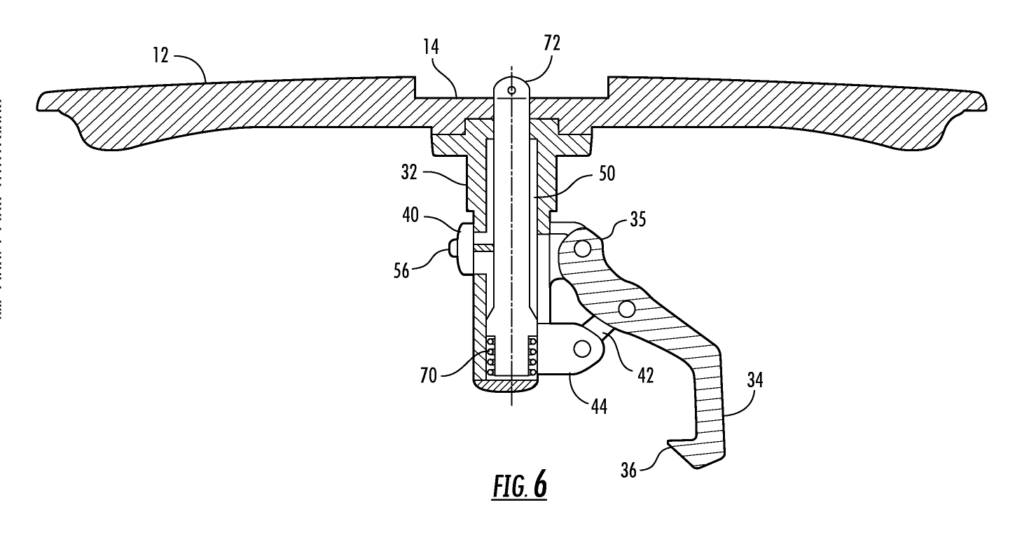

Another alternative arrangement, illustrated in a simplified form in FIG. 6, involves the shaft 50 being biased by a spring 70 to an upper position in the body, that is, closest to the wheel cover. The collar 40 is connected to the shaft, eliminating the carrier. The spring 70 biases the collar and gripping members to the gripping position. A button 72 is placed on the end of the shaft 50 and is accessible in the hole 14 in the wheel cover. By pressing on the button 72, the shaft 50 and collar 40 are moved axially downward, and the gripping members are moved to the released position. When the button 72 is released, the shaft 50 and collar 40, under force of the spring, move to the upward position and the gripping members 34 to the closed position.

Other arrangements are possible. For example, the spring could be a pneumatic spring.

The invention has been described in terms of preferred principles, embodiments and components, however, those skilled in the art will recognize that substitutions may be made without departing from the scope of the invention as defined by the appended claims.

What is claimed is:

1. A wheel cover and mounting device, comprising:
a wheel cover;
a hub gripping device for releasably gripping an axle hub, the huh gripping device having a body supporting the wheel cover at a first end and having hub gripping members at a second end;
a handle attached to the first end of the hub gripping device, the handle operatively connected to the gripping members lot selectively moving, the gripping, members between a gripping position and a release position.

2. The wheel cover of claim 1, further comprising:
a threaded shaft disposed in the body, wherein the handle is connected for selectively rotating the threaded shaft about a long axis;
a collar disposed for sliding on the body, the gripping members being pivotally mounted to the collar;
a threaded carrier disposed in an annular space between the threaded shaft and the body, the collar being attached to the threaded carrier,
wherein, the threaded carrier is engaged with the threaded shaft so that rotation of the threaded shaft about the axis causes axial movement of the threaded carrier and collar, wherein said axial movement causes the gripping members to pivot, rotation in a first direction moving the gripping members to a gripping position and rotation in a second direction moving the gripping members to a release position.

3. The wheel cover of claim 2, further comprising a cuff fixed to the body and links pivotally connected to the cuff and pivotally connected to the gripping members, the links controlling pivotal movement of the gripping members.

4. The wheel cover of claim 1, wherein body of the hub gripping device comprises a hollow cylinder having a flange supporting the wheel cover

5. The wheel cover of claim 1, wherein the gripping members comprise hooked tongs, the tongs each being pivotally attached at a first end to a collar movably mounted to the body and being pivotally connected by a link to a cuff fixed to the body, movement of the collar causing the tongs to move between gripping and release positions, the handle being operatively connected to the collar.

6. The wheel cover of claim 1, wherein the handle includes a cam and is connected to a shaft, the body including a cam surface and the shaft being, mounted for axial movement in the body, the shaft being connected to a collar on which the gripping members are pivotally mounted, wherein pivoting movement of the handle causes axial movement of the shaft and collar and pivoting of the gripping members.

7. The wheel cover of claim 1, wherein the handle includes a cam and is connected to a shaft, the body including a cam surface and the shaft being mounted for axial movement in the body, the shaft being connected to a collar on which the gripping members are pivotally mounted, wherein turning movement of the handle causes axial movement of the shaft and collar and pivoting of the gripping members.

8. The wheel cover of claim 1, wherein the body comprises a hollow cylinder mounted to the wheel cover, and further comprising:
a shaft disposed in the body and biased toward the wheel cover, wherein the handle is connected for selectively pushing the shaft in an axial direction;
a collar disposed for sliding on the body and interconnected with the shaft, the gripping members being pivotally mounted to the collar; and,
a cuff fixed to the body, the cuff haying links connected to the gripping members for controlling pivotal movement of the gripping members as the collar slides;
wherein, axial movement of the shaft causes the gripping members to pivot between the gripping position and the release position.
